(19) United States
(12) Patent Application Publication
(10) Pub. No.: US 2003/0118760 A1
(43) Pub. Date: Jun. 26, 2003

(54) Flexible tube coated with layer having diffusion barrier effect to gases and aromas

(76) Inventors: Mohamed Benmalek, Saint Martin D'Heres (FR); Alain Jupin, Sainte Menehould (FR)

Correspondence Address: Paul D Greeley, Ohlandt Greeley Ruggiero & Peerle, One Landmark Square 10th Floor, Stamford, CT, 06901-2682, US

(21) Appl. No.: 10/168,903

(22) PCT Filed: Dec. 21, 2000
(86) PCT No.: PCT/FR00/03635

(51) Int. Cl. B32B 1/08; H05H 1/24

(52) U.S. Cl. 428/35.4; 427/569

(57) ABSTRACT

A flexible tube designed to store and dispense liquid-to-pasty products containing fragrances, aromas or [substances] sensitive to oxidation, whose wall bears over its entire surface a coating comprising a layer of thickness comprised between 150 and 1500 Å of a material or a mixture of materials belonging to the following group: hydrogenated or non-hydrogenated, nitrogenated or non-nitrogenated amorphous carbon, oxides, nitrides or carbides or their mixture or their combination with one or more of the following metals (Si, Mg, Al, Ti, Zr, Nb, Ta, Mo, W, V). Preferably, this is an internal coating. The coating is created by means of a plasma, preferably under atmospheric pressure, by decomposition of a gaseous compound and condensation on the substrate or even by means of a plasma ribbon. The coating can be mixed or gradual: for example, carbon with polymeric tendency in the sublayer and silica on the surface.

### TECHNICAL FIELD

The invention concerns a manufacturing process for flexible tubes typically designed to store and distribute liquid-to-pasty products containing fragrances or aromas or [substances] sensitive to oxidation.

### STATE OF THE ART

Flexible tubes previously were metal or metal-plastic and had, due to the presence of a metal layer, a perfect barrier property relative to vapor and aromas and to different gases (notably oxygen).

In numerous fields, metal tubes, obtained by shock extrusion of an aluminum piece, have been progressively replaced by metal-plastic tubes and then by entirely plastic tubes. Plastic or metal-plastic tubes are preferably mass-produced by injection of a plastic head and then welding or bonding—possibly simultaneously—of said plastic head onto a cylindrical skirt, obtained by cutting a sleeve at a given length, said sleeve being itself obtained by extrusion—or coextrusion if it is multilayered—(extruded skirt) or even by welding or bonding the lateral edges of a rolled-up strip such that said lateral edges face one another (laminated skirt).

The transition from metal-plastic tubes to entirely plastic tubes has been for the most part imposed for reasons of recycling multilayer metal-plastic films. But it has become necessary to replace the metal layer of the metal-plastic structure by a polymer layer conferring satisfactory barrier properties to the assembly. Such a material could not be found among the polyolefins currently used for flexible tubes, which are less expensive products [that are produced] in very large quantities. One thus resorts to laminated structures, made up of several coextruded layers comprising at least one layer with a diffusion barrier effect, of a plastic such as EVOH (ethylene-vinyl alcohol copolymer), certain polyamides (PA) or modified polyamides. Application EP 0 612,612 describes such a structure: the EVOH layer is an intermediate layer between two polyolefin layers, which can themselves be a superimposition of low-density polyethylene sublayers, of low-density linear polyethylene and/or of high-density polyethylene, each layer being connected throughout its surface to the EVOH layer by means of adhesive layers of the EAA type (ethylene-acrylic acid copolymer) or EMA (ethylene-methacrylic acid copolymer).

The head of the tube, bonded onto the flexible skirt, has a neck for distribution and a shoulder which connects the neck to the skirt. The distribution opening is sealed, for example, by screwing a sealing cap onto the neck (capping) and the skirt+capped head is delivered to the packagers. This assembly is then presented head down so that the packager can fill it through the end of the skirt that remains open. After filling, said end remaining open is then bonded and the tube, delivered for sale, must be able to preserve the quality of the product that it contains during several months of storage. Although the amount of loss has been low since the appearance of entirely plastic skirts whose structure is comparable to that described above, the problem of loss of aroma at the level of the head is still posed, the head being generally made by molding of a polyolefin. Three groups of solutions have been proposed in response to this problem.

The first group of solutions consists of adding a metal-plastic or plastic insert making a diffusion barrier at the level of the neck and shoulder. In general, this insert is positioned inside the tube, at the level of the shoulder and the neck. It can be molded of a single material, preferably PBT (polybutylene terephthalate), or have several layers. In application EP 0 524,897 of the Applicant, such an insert is made by thermoforming, starting from a laminate having a structure comparable to that of the multilayer skirt described previously, i.e., polyolefin(s)—adhesive layer—EVOH—adhesive layer—polyolefin(s).

A second solution consists of totally changing the way of making the head. In Patent EP 0 680,444, the Applicant proposes shaping the head by heat-shrinking one end of the skirt made up of a laminate having a barrier-effect layer. The shrinking is done by formation between matrices [dies] of folds of scrap material, flattening of these folds, then over-molding of the shoulder and the outline of the neck which have been made with a polyolefin so as to obtain the final shape of the head.

Finally, a third solution consists of making the head of a multilayer polyolefin-EVOH-polyolefin by co-injection, as International Application WO99/02525 describes, presented by the Applicant.

Problem Posed

The presence of a material with barrier properties such as EVOH has a certain number of disadvantages, due to the cost of this material and the difficulties of using a multilayer comprising a barrier layer of this type. These difficulties of use, already great relative to the skirt, are still greater with regard to the head, when one seeks to also obtain a diffusion barrier effective at the level of the shoulders and the neck.

For both the head and the skirt, it is recommended to place the barrier layer in the middle of the multilayer, since a minimal thickness of internal layers, typically of polyethylene (PE), is designed to protect the barrier layer from the product contained in the tube. In fact, this dentifrice paste or cosmetic product, food product, etc., is generally made up of a large quantity of water, and EVOH, which is particularly sensitive to humidity, in case of contamination, loses a large part of its barrier properties.

With regard to the structure of the skirt, the EVOH layer must be sufficiently thick to have effective barrier properties but must not be too thick with regard to the other layers: EVOH is particularly rigid and elastic, which degrades the “dead fold” property of the multilayer obtained. This property, sometimes translated by the term “crushability”, characterizes a behavior of plasticity in bending, with weak elastic rebound effect on the angle of folding. The compromise found, for completely satisfactory barrier properties, imposes a relatively large total thickness of the multilayer. Moreover, with regard to laminated tubes, a poorer diffusion barrier is observed for gases and fragrances at the level of the longitudinal bond, which is certainly due to the use of local melting of the different components of the multilayer and to deformations due to stresses generated by the joining or superimposition of the longitudinal edges of the strip.

With regard to the head, none of the three groups of solutions presented above—creation and positioning of a barrier insert, shrinking of the multilayer skirt, [or] coinjection, is very satisfactory economically, either with regard to the first group, since it complicates the production line and slows the production rate, or with regard to the other [two] groups, since they require the replacement of numerous machines and impose high investment costs.

The object of the invention is to define a process that permits, for laminated tubes as well as extruded tubes, obtaining a head structure and a skirt structure free of a barrier material such as EVOH, which is rigid and difficult to coinject with polyolefins and which has, in the absence of an insert and for the same total thickness of the skirt—typically 250-500 microns—barrier properties and a crushability at least as good as those of the structure of the prior art, the barrier properties moreover being roughly homogeneous throughout the periphery of the skirt, even for laminated tubes (which have a longitudinal weld or bond).

### Subject of the Invention

The first subject of the invention is a flexible tube provided with a skirt and a head, designed to store and distribute liquid-to-pasty products containing fragrances, aromas or [substances] sensitive to oxidation, characterized in that said tube bears over the entire surface of its wall, that is to say, on the surface of the neck and shoulder and the skirt, a coating including at least one layer of a thickness comprised between 150 and 1500 Å of a material or of a mixture of materials belonging to the following group: hydrogenated or nonhydrogenated, nitrogenated or non-nitrogenated amorphous carbon, oxides, nitrides or carbides or their mixture, or their combination of one or more of the following metals (Si, Mg, Al, Ti, Zr, Nb, Ta, Mo, W, V).

By “hydrogenated or nonhydrogenated, nitrogenated or non-nitrogenated amorphous carbon” is meant a material with a polymeric tendency, characterized by a network of amorphous carbon chains which can contain hydrogen or nitrogen bonds.

With such a coating, the wall of the flexible tube according to the invention can be free of any of these polymeric layers with barrier properties described previously, which are rigid and difficult to inject. The coating itself, although its thickness is limited to that of the layer according to the invention, confers satisfactory barrier properties to the structure of the wall of the tube. The thickness of the coating is variable depending on the chosen material. It is limited so that the deposited layer remains flexible with regard to its substrate and thus preserves an improved mechanical strength during manipulations of the skirt. It must therefore be sufficiently thick in order to confer barrier properties which are translated to the structure:

for oxygen, by a permeability of less than 1 ml/m²/day/atmosphere (ASTM standard D3985)

for water vapor, by a permeability of less than 2 g/m²/day/atmosphere (ASTM standard F327)

and for aromas, by a permeability of less than 0.5×10⁻⁶ g/m²/day/mmHg.

The wall of the flexible tube according to the invention comprises, both at the level of the head and that of the skirt, at least one thermoplastic material such as a polyolefin or a polyester of the polyethylene terephthalate (PET) type or a copolyester. In the case of a multilayered structure of the skirt—and possibly of the head—said thermoplastic material comprises the wall of the tube which serves as the substrate receiving the deposit. Preferably, in order to improve still further the crushability properties of the skirt, at least one layer of the structure of the skirt comprises a polymer filled with a powdered material such as calcium carbonate or mica.

Preferably, the coating covers the inside surface of the wall of the tube which protects it from the risks of scratching or flaking due to shocks on the external surface and also retains all the possibilities for deposition of decorative paint or printing on said outer surface.

Another subject of the invention is a supplemental step of the process for manufacture of flexible plastic tubes in which the surface of the tube is coated—after joining of the head to the skirt, typically by bonding—by conducting a plasma-assisted deposition of a layer of a thickness comprised between 150 and 1500 Å of a material or a mixture of materials belonging to the following group: hydrogenated or nonhydrogenated, nitrogenated or non-nitrogenated amorphous carbon, oxides, nitrides or carbides, or their mixture, or their combination with one or more of the following metals (Si, Mg, Al, Ti, Zr, Nb, Ta, Ma, W, V).

The deposition can be conducted either on the outer surface or on the inner surface of the flexible plastic tube. The examples which follow will illustrate, except when otherwise stated, deposits of internal coatings, but can easily be transposed to deposits of external coatings.

Preferably, this deposition is conducted on the surface of the tube, at a rate compatible with the production rates of industrial production, typically a hundred or several hundred tubes per minute.

According to the invention, this deposition is conducted by using a plasma reactor for surface treatment. The plasma can be generated under different types of discharges: arc, luminescent discharge, discharge across a dielectric barrier or discharge of the corona type with different types of excitation: microwave, radiofrequency, [or] alternating current of intermediate frequency. The last two types of plasma generation have the advantage of being able to be conducted under a pressure close to atmospheric pressure.

The coating is obtained by condensation after decomposition of a substance or a gaseous compound and the plasma can be generated:

either by low, intermediate or high frequency excitation or even by microwaves. In this case, the operating pressure can vary between one-hundredth and one-thousandth torr,

or by dielectric barrier discharge or corona-type discharge. In this case, the operating pressure can be close to atmospheric pressure, which is important, since the treatment time can be notably decreased.

In the case where the operating pressure must be very low, it is preferable to conduct the coating treatment in “batch” [mode] on a quantity of tubes that is compatible with the continuous flow of tubes originating from the production line plus the time necessary to obtain a high vacuum. In contrast, if the operating pressure is close to atmospheric pressure, one can envision conducting the treatment during the manufacturing cycle.

When the operating pressure is very low, the batch treatment is preferably conducted in a vacuum chamber into which is introduced the desired quantity of tubes to be treated, these latter being at this stage in the form of a head comprising a neck and a shoulder, said head being assembled with a flexible skirt. A cylindrical electrode assembly is introduced through the open end of the skirt, [this assembly] comprising an external electrode surrounding the skirt of the tube and an internal electrode entering the inside of the tube from the top of the skirt, and the precursor gas is injected through said open end in such a way that the plasma can move towards the shoulder and neck. Thus, the deposition can be made downstream of the plasma formation zone and its thickness is greater closer to the skirt, which is clearly the objective sought. By playing with the flow rate of the precursor gas and the excitation parameters of the plasma, it is possible to extend to a greater or lesser degree, the zone where the plasma remains active to assist with the deposition.

In the case of working under pressure close to atmospheric pressure, the plasma can be generated:

either by dielectric-barrier discharge or corona-type discharge between two electrodes, one introduced inside the flexible tube and the other placed outside.

or by using a mode of confined plasma generation in the form of a ribbon of given length.

With a working pressure close to atmospheric pressure, the time for the deposition treatment is notably reduced, integrated into the production line or performed off-line (in batch), [and] this treatment becomes economically compatible with manufacturing rates for tubes which are of the order of several hundred units per minute.

Deposition, which is conducted under a pressure close to atmospheric pressure and assisted by a plasma generated by barrier or corona discharge, can be integrated into the production line, immediately after bonding the head onto the skirt, but preferably before positioning of the sealing cap on the neck: the flexible tube at this stage has both its ends open and thus has a favorable configuration for free circulation of the precursor gas, which can easily cross the inner volume of the tube from one end to the other.

The device permitting generating of plasma by barrier discharge can comprise an assembly of internal and external electrodes similar to the one described in the preceding example (relative to the generation of plasma under low operating pressure).

In order to conduct a corona-type discharge, a device with two electrodes having an axial symmetry is also used, the axes of symmetry of the flexible tube and the electrodes coinciding. An internal electrode can be introduced through the open end of the flexible tube into the inside of the flexible tube, and the tube is rotated, possibly [together] with the external electrode, around the internal electrode. The internal electrode has axial convexities, allowing longitudinal ridges to appear in the form of blades orientated radially and its surface, with a spacing of a few millimeters (typically 3), assumes the shape of the internal surface (skirt+shoulder+neck) of the flexible tube. The relative rotational movement of the internal electrode and of the flexible tube permits eliminating point effects which can lead to the appearance of zones with degraded appearance.

The device which uses a confined plasma-generation mode in the form of a ribbon of given length can be adapted from the one disclosed in FIG. 10 and in Example 3 of Application WO 99/46964. Here, axially symmetrical electrodes placed on either side of the flexible tube are not used, but rather an assembly of outer electrodes, one placed facing an open end of the flexible tube and the other, coated with a dielectric, roughly assuming the form, with an appreciably constant offset, of the generating line of the flexible tube. The tube is rotated so that its wall runs in front of the lateral electrode and the deposition can thus be realized over the entire circumference.

With such a device, one can envision conducting the process at the end of the manufacturing cycle, after bonding of the head onto the skirt and even after positioning the sealing cap on the neck. The tube can in fact be processed provided with its sealing cap, since the plasma is confined to a ribbon of controlled dimension and it is not necessary to provide an opening at each end of the tube in order to facilitate the circulation of the plasma.

Regardless of the plasma generation process chosen, one seeks a deposit thickness comprised between 150 Å and 1500 Å, preferably less than 300 Å. The material to be deposited can be any material having good aroma and gas-diffusion barrier properties. Preferably, carbon with polymeric tendency is chosen, i.e., comprising an amorphous carbon chain network with hydrogen bonds, silica or alumina.

For the deposition of silica, preferably HMDSO (hexamethyl-disiloxane) or TMDSO (trimethyl-disiloxane) is used as a precursor gas. For the deposition of alumina, preferably an organometallic compound gas is used as the precursor gas such as tributylaluminum Al(C₄H₉)₃ or triethylaluminum, that can be circulated diluted in an argon and oxygen mixture. By playing with the proportion of oxygen, depositions containing a certain amount of reactive carbon as high as 20% are created. The Applicant has observed a more ductile behavior of deposits such as obtained when the deposit is richer in carbon, doubtless because the silica or alumina network, in which the carbon must be incorporated, is looser.

In addition, when a carbon deposition is made, it is preferable to mix the chosen precursor (acetylene, for example) with one of the above-mentioned gases (HMDSO, TMDSO, tributylaluminum or triethylaluminum) so as to obtain improved barrier properties. The mixture is determined in such a way that the aluminum or silicon content of the deposit is close to or less than 5%. It is in fact a question of improving the adherence of the deposit on the substrate without overly degrading the ductile behavior of the deposit.

Finally, by using a mixture of two precursor gases and varying over time the additional compositions of the gases of the mixture, it is possible to obtain a gradual deposit, first of layers rich in a first element and then progressively enriched with a second element. Thus, an acetylene-HMDSO-argon mixture in which the proportion of argon is kept at 40% and the proportion of acetylene and HMDSO respectively is from 50%-10% to 10%50% permits conducting a gradual deposition of layers, first rich in amorphous carbon and then rich in silica—the proportion is expressed in terms of the flow rate: in the form of a standard unit of volume per unit of time (typical unit of flow rate (sscm (standard cubic centimeter per minute)). Hydrogenated amorphous carbon, which is situated in a sub-layer, assures a better bond on the polymeric substrate, typically polyethylene, of the flexible tube and assures a greater flexibility for the coating obtained. The silica layer completes the barrier effect of the carbon layer while limiting the discoloration due to carbon. The outer coating thus obtained, comprising a large proportion of silica on the surface, is better adapted to the conditions required for the final printing of the tube skirt.

Regardless of the plasma generation process chosen, one seeks a deposit thickness comprised between 150 Å and 1500 Å, preferably between 200 and 500 Å. 100 Å/s is envisioned as the order of magnitude of the deposition rate. The latter is of the order of 50 Å/s when a cold plasma is used (corona or dielectric discharge); in contrast, it can surpass 300 Å/s with a thermal-type plasma. Thus, the duration of the deposition can be limited to a few seconds, or even a few tenths of seconds.

In the case of a treatment requiring a high vacuum, it is necessary to take into account the duration of pumping to obtain the desired vacuum. In order to obtain the primary vacuum as rapidly as possible, one uses “roots” type pumps. The operating pressure of the deposit is comprised between 50 and 1000 Pa. The chamber, which is designed to contain the tubes, of inner volume as small as possible, is provided with pumping means associated with “roots” type pumps able to create the primary vacuum in a few seconds. The secondary vacuum sought is obtained by means of a turbomolecular pump or by diffusion.

In the case of treatment under pressure close to atmospheric pressure, one preferably operates between 200 and 760 millimeters of mercury. A pressure slightly lower than atmospheric pressure permits better controlling the purity of the gas circulating in the container. Preferably, a pre-sweeping is carried out with an inert gas of the argon type, to prevent the formation of impurities (risk of reaction with the nitrogen of air, water vapor, etc.) which can deteriorate the quality of the adherence of the layer thus deposited. Being able to work under a pressure close to atmospheric pressure permits envisioning the economically satisfactory use of non-static devices, such as means for rotating the tube, which permits simplifying the electrodes and regularizing the stability of the plasma by confining it to the shape of a ribbon.

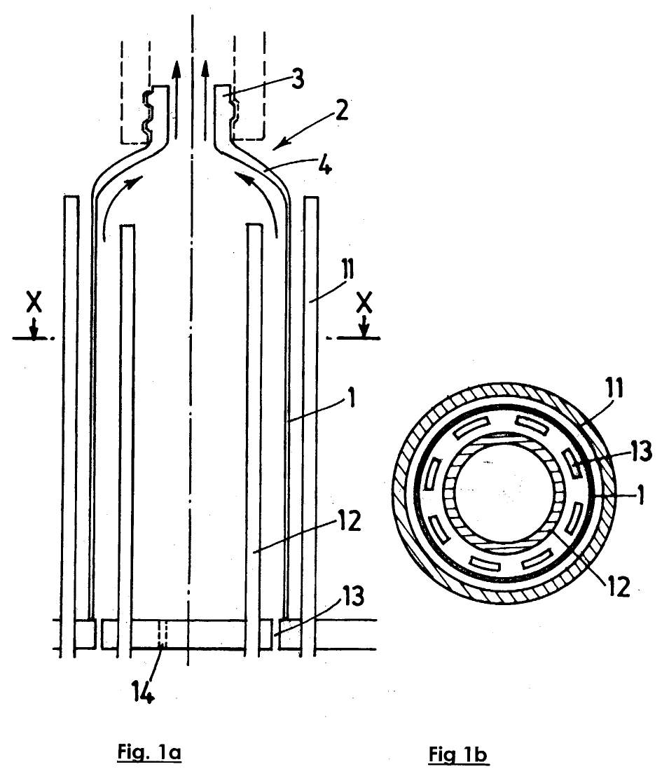

FIG. 1 diagrams in axial section (1a) and in orthogonal section (1b) a first device designed to implement the process according to the invention by generation of a plasma under low pressure.

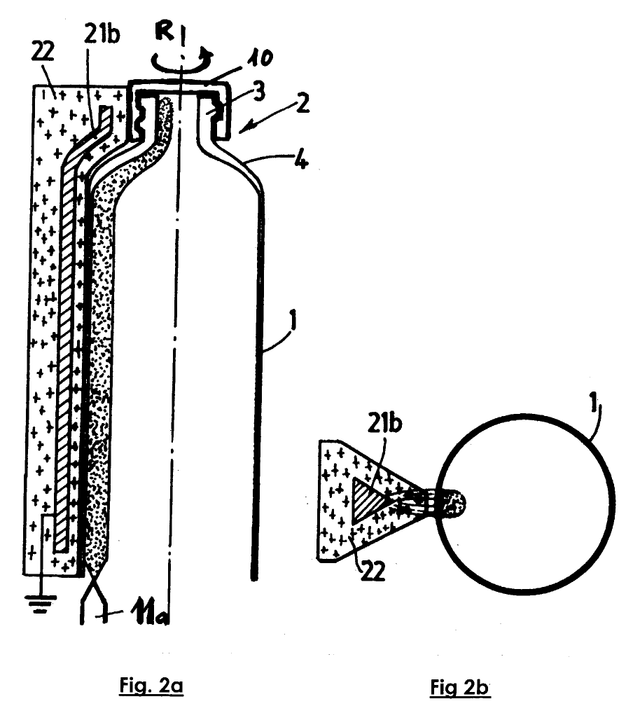

FIG. 2 shows in axial section (2a) and orthogonal section (2b) a second device designed to implement the process according to the invention by using a means for generating a plasma confined to the shape of a ribbon.

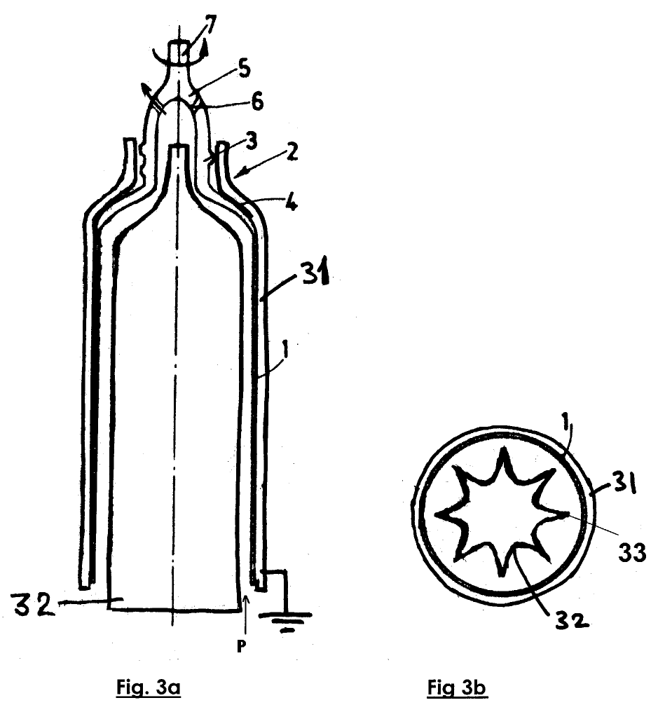

FIG. 3 shows in axial section (3a) and orthogonal section (3b) a third device designed to implement the process according to the invention by generation of a plasma by corona-type discharge.

### EXAMPLES

### Example 1

### Plasma-Assisted Deposition Under Low Pressure on the Inner Surface of the Wall of a Flexible Tube (FIGS. 1a and 1b)

The flexible tube, comprising a skirt 1 and a head 2, with a roughly cylindrical neck 3 and a shoulder 4, is placed in a vacuum chamber, and rests on a plate, the skirt being surrounded by two cylindrical coaxial electrodes 11 and 12, the axis of the tube and the axis of the electrodes coinciding. External electrode 11 surrounds skirt 1 up to the level of the shoulder. Internal electrode 12 entering inside the tube has a height slightly less than that of the skirt.

An argon-acetylene mixture is introduced with a C₂H₂/Ar ratio of the order of 10% and injected through openings 13. The pressure during deposition is of the order of 0.25 torr. External electrode 11 is grounded while internal electrode 12 is under a voltage of the order of 20 kV, pulsed at a frequency of the order of 250 kHz. Under the effect of the flow of precursor gas supply, the plasma is driven toward the shoulder and the neck. Thus, the deposition can be conducted downstream of the plasma formation zone.

### Example 2

### Plasma-Assisted Deposition Under Low Pressure on the Inner Surface of the Wall of a Capped Flexible Tube

In this variant of the preceding example, the tube is in the state in which it usually leaves the production line, i.e., already equipped with its sealing cap.

An opening 14 (broken line in FIG. 1a) is made in the support. By permitting the evacuation of gases, a circulation close to that described in the preceding example is imposed, the neck, however, being less easily reached. In order to improve the stability of the plasma, the internal cylindrical electrode is mounted on a shoulder “parallel” to the shoulder of the tube, which remains at a constant distance from said wall. External electrode 11, still cylindrical, has a height a little less than that of the preceding example.

### Example 3

### Plasma-Assisted Deposition Under Pressure Close to Atmospheric Pressure of a Layer of Silica on the Inner Surface of a Flexible Tube (FIGS. 2a and 2b)

The device employed in this example uses a mode of generation of a confined plasma in the shape of a ribbon of a given length adapted to that disclosed in FIG. 10 and in Example 3 of Application WO 99/46964, so that the plasma ribbon takes on the shape of the generating line of the flexible tube. Here, axially symmetric electrodes placed on either side of the flexible tube are not used, but rather an external electrode assembly, one 11a positioned facing the open end of the flexible tube and the other 21b, roughly assuming the shape, with a more or less constant spacing, of the generating line of the flexible tube. The tube is rotated (R) in such a way that its wall travels in front of the lateral electrode and deposition can be produced over the entire circumference.

The treatment may be conducted on the tube alone, before or after coring the end of the head (see the following example). In the present case, it is conducted at the very end of the production cycle, after bonding the head onto the skirt and after the positioning of the sealing cap 10 on neck 3. The tube can thus be treated provided with its sealing cap since the plasma is confined to a ribbon of controlled dimension and it is not necessary to provide an opening at each end of the tube to facilitate the circulation of the plasma.

Lateral electrode 21b and its insulating envelope 22 have a configuration close to that shown in FIGS. 10a and 10e of WO99/46964. Preferably a pulsed current is used, each pulsed discharge having for an effect treating a part of the inner surface of the tube in the form of a strip of given width, depending in particular on the rotational speed of the tube. Such a procedure, which permits treating the whole surface by conducting an appropriate offsetting of these strips, has the advantage of limiting overheating since the plastic material of the tube has the time to cool between pulses: this time is even longer when non-adjacent strips are treated.

### Example 4

### Plasma-Assisted Deposition Under Pressure Close to Atmospheric Pressure of a Mixed Layer of Silica and Carbon with Polymeric Tendency on the Inner Surface of a Flexible Tube (FIGS. 3a and 3b)

The system is arranged in such a way that the tube leaves the classical production line while the head is not yet cored. End 7 of injection core 5 is used to hold and drive the tube in rotation (R). Vents 6 are arranged in core to permit circulation of the plasma in the direction of the neck.

The tube is introduced into the cavity of outer electrode 31, whose inner surface takes on the outer shape of the tube. An internal electrode 32 is introduced through the open end of the flexible tube to inside the latter and the tube is rotated by means of end 7 of the core around internal electrode 32. Internal electrode 32 bears axial convexities creating longitudinal ridges 33 in the form of blades oriented radially. The surface envelope of said electrode, with a gap of 3 millimeters, assumes the form of the inner surface (skirt 1+shoulder 4+neck 3) of the flexible tube. The relative rotational movement of the internal electrode and the flexible tube permits preventing point effects that can lead to the appearance of zones of degraded appearance.

External electrode 31 is grounded and 20 kV are applied onto internal electrode 32. The gas, an acetylene-HMDSO-argon mix, whose flow rate corresponds, respectively, to 20 sscm, 10 sscm and 15 sscm (sscm being a unit indicating standard cm³ per minute) is injected (P) through the open end of the flexible tube. It circulates between internal electrode 32 and the inner wall of the flexible tube and is evacuated by vents 6 arranged in core 5.

The plasma is generated between the ridges of the electrode and the inner wall of the tube by means of a source excited at a frequency of 250 kHz. The tube is rotated throughout the duration of treatment. Several seconds suffice for obtaining a regular deposit of the order of 250 Å. The coating is a mixed deposit of silica and carbon with polymeric tendency.

Advantages of the Process According to the Invention

Possibility of reducing the thickness of the tube skirt: savings in the cost of raw materials;

Absence of rigid material: improved “dead fold” properties;

Possibility of choosing the optimal mixture of materials with regard to the compromise between flexibility and barrier properties;

The deposit is thin and deformable: the barrier properties are maintained even after aggressive use of the flexible tube.

This process is also applicable to tubes obtained by injection and molding in one piece.

1. A flexible tube supplied with a skirt (1) and a head (2) having a neck (3) and a shoulder (4) connecting said neck to said skirt, designed to store and dispense liquid-to-pasty products containing fragrances, aromas, or [substances] sensitive to oxidation, characterized in that said tube bears over the entire surface of its wall, i.e., the surface of neck (3), shoulder (4) and skirt (1), a coating comprising at least one layer of a thickness comprised between 150 and 1500 Å of a material or mixture of materials belonging to the following group: hydrogenated or nonhydrogenated, nitrogenated or non-nitrogenated amorphous carbon, oxides, nitrides or carbides, or their mixture, or their combination with one or more of the following metals (Si, Mg, Al, Ti, Zr, Nb, Ta, Mo, W, V).

2. The flexible tube according to claim 1 wherein the surface of the wall of the tube bearing said coating is the inner surface.

3. The flexible tube according to claim 1 wherein the surface of the wall of the tube bearing said coating is the outer surface.

4. The flexible tube according to claim 1, further characterized in that said layer of a thickness comprised between 150 and 1500 Å confers barrier properties to said skirt, which are translated:
for oxygen, by a permeability of less than 1 ml/m²/day/atmosphere (ASTM standard D3985)
for water vapor, by a permeability of less than 2 g/m²/day/atmosphere (ASTM standard F327)
and for aromas, by a permeability of less than 0.5×10⁻⁶ g/m²/day/mmHg.

5. The tube according to any one of claims 1 to 4 wherein said head and said flexible skirt comprise at least one layer of a thermoplastic material such as a polyolefin, a polyester of the polyethylene terephthalate type (PET) or a copolyester.

6. The tube according to any one of claims 1 to 5, further characterized in that said skirt comprises at least one layer of a polymer filled with a powdered material such as calcium carbonate or mica.

7. A manufacturing process for flexible plastic tubes comprising a step of shaping a cylindrical skirt, the creation of a head provided with a shoulder and a neck, then assembly of said cylindrical skirt and the head, typically by bonding, characterized in that it comprises a final step of deposition over the entire surface of said tube of a coating comprising at least one layer of a thickness comprised between 150 and 1500 Å of a material or of a mixture of materials belonging to the following group: hydrogenated or nonhydrogenated, nitrogenated or non-nitrogenated amorphous carbon, oxides, nitrides or carbides or their mixture or their combination with one or more of the following metals (Si, Mg, Al, Ti, Zr, Nb, Ta, Mo, W, V).

8. The process according to claim 7 wherein the coating is deposited by means of a plasma under a pressure close to atmospheric pressure.

9. The process according to claim 8 wherein the material of the coating is obtained by condensation after decomposition of a substance or a gaseous chemical compound, and wherein the plasma is generated under the effect of a dielectric-barrier discharge or a corona discharge.

10. The process according to claim 8 wherein the plasma is generated by using a mode of plasma confined to the shape of a ribbon of given length.

11. The process according to any one of claims 7 to 10 in which precursor gases are mixed so as to obtain the deposition of a mixed coating.

12. The process according to any one of claims 7 to 10 in which a mixture of precursor gases is made, by varying over time the complementary compositions of the gases of the mixture, so as to obtain a gradual deposit of layers first rich in a first element and then progressively enriched with a second element.

13. A flexible tube according to any one of claims 1 to 6 in which said coating is a gradual deposition of layers first rich in a first element of the group described in claim 1 and then being progressively enriched with a second element of said group described in claim 1.

14. The flexible tube according to claim 13 in which said coating comprises a sublayer rich in carbon with polymeric tendency and a sublayer of silica or alumina on the surface.
